(19) United States
(12) Patent Application Publication
(10) Pub. No.: US 2006/0253620 A1
(43) Pub. Date: Nov. 9, 2006

(54) Data structure of flash memory having system area with variable size in which data can be updated, USB memory device having the flash memory, and method of controlling the system area

(76) Inventor: Byung-suk Kang, Yongin-si (KR)

Correspondence Address: CANTOR COLBURN, LLP, 55 GRIFFIN ROAD SOUTH, BLOOMFIELD, CT, 06002, US

(21) Appl. No.: 11/417,580

(22) Filed: May 4, 2006

(30) Foreign Application Priority Data
May 6, 2005 (KR) 10-2005-0037808
Jul. 22, 2005 (KR) 10-2005-0066617

(51) Int. Cl. G06F 3/00

(52) U.S. Cl. 710/36

(57) ABSTRACT

Disclosed is a data structure of a flash memory having a system area with variable size in which data can be updated, a Universal Serial Bus (USB) memory device having the flash memory, and a method of controlling the system area. The data structure of the flash memory in the USB memory device includes: a system area in which a user is not allowed to record or delete data, management information of the USB memory device and a program or content executed or played upon connecting the USB memory device to a host are recorded, and a program or content is added or updated by an update program.

### BACKGROUND OF THE INVENTION

This application claims the priorities of Korean Patent Application Nos. 2005-37808, filed on May 6, 2005, and 2005-66617, filed on Jul. 22, 2005, in the Korean Intellectual Property Office, the disclosures of which are incorporated herein in their entireties by reference.

1. Field of the Invention

The present invention relates to a data storage technology and, more particularly, to a data structure of a flash memory having a system area with variable size in which data can be updated, a Universal Serial Bus (USB) memory device having the flash memory, and a method of controlling the system area.

2. Description of Related Art

With the development of data storage technology, various kinds of portable memory devices have been recently used. A USB memory device, as one of the portable memory devices, is typically equipped with a USB interface and a flash memory. The USB memory device features large storage capacity, portable convenience, and easy connection to other devices such as personal computers (PCs). Because of these features, it has been widely used in storing music files, image files, and moving picture files. The flash memory is a type of EEPROM (electrically erasable and programmable read-only memory), and is divided into NOR type, which performs input/output operations in byte mode, and NAND type, which performs input/output operations in page mode.

Meanwhile, a data storage area of a flash memory is divided into a system area in which data cannot be deleted nor written by a user, and a user data area (public area) in which data can be read, deleted, or written by a user. In the system area, management information of a USB memory device, and programs executed or contents played by a host (e.g., autorun program) when the USB memory device is first identified by a USB host (e.g., when the USB memory device is inserted into a USB slot of a PC) are stored.

Conventionally, since the size of the system area is determined upon the manufacture of a USB memory device, a user cannot change the size of the system area nor update programs or contents stored in the system area.

Accordingly, there is a problem in that a USB memory device has to be collected to reformat or update programs or contents stored in a system area of the USB memory device by means of a specific device or a system program.

### SUMMARY OF THE INVENTION

The present invention provides a data structure of a flash memory having a system area with variable size in which data can be updated, a Universal Serial Bus (USB) memory device having the flash memory, and a method of controlling the system area.

According to an aspect of the present invention, there is provided a data structure of a memory in a USB memory device, including: a system area in which a user is not allowed to record or delete data, management information of the USB memory device and a program or content executed or played upon connecting the USB memory device to a host are recorded, and a program or content is added or updated by an update program.

The data structure may further include a public area in which a user is allowed to record and delete data.

The system area may include: a hidden area in which a user is not allowed to record and delete data, and management information of the USB memory device or a program to be executed or content to be played is recorded; and a system read/write area in which a user is not allowed to record and delete data, and a program executed or content played upon connecting the USB memory device to a USB host is recorded.

The system read/write area and the hidden area may vary in size.

The hidden area may not be displayed through a file explorer incorporated in the host.

The system area may store an authentication key necessary in executing or playing a program or content recorded on the system area, a public area, the host, or a remote server, or in acquiring authority to access user data recorded on the public area or to access the remote server connected to the host.

The update program may be stored in the system area or public area of the memory, the host, or a remote server.

The update program may transmit program or content information recorded on the system area or public area of the USB memory device to the host or a remote server.

The system area may store the same information as at least one program or content stored in a public area, and, if the program or content stored in the public area is deleted, a corresponding program or content may be copied from the system area to the public area.

The public area, the hidden area, or the system read/write area may store a program or content downloaded from a host or a remote server by a predetermined update program.

The hidden area may store information created or processed in executing a program stored in the system read/write area, the public area, or the host.

According to another aspect of the present invention, there is provided a USB memory device including: at least one flash memory; a USB interface; and a controller that receives an update command for updating data stored in a system area of the flash memory in which a user is not allowed to record and delete data, and performs an update process.

The flash memory may include a system area in which a user is not allowed to record or delete data, management information of the USB memory device and a program or content executed or played upon connecting the USB memory device to a host are recorded, and a program or content is added or updated by an update program.

The flash memory may further include a public area in which a user is allowed to record and delete data.

A part or the entire of a program or content stored in the system area may be stored in a host or a public area, and a program or content stored in the host or the public area is updated.

The controller may use an EEPROM rather than a ROM to update a system program to another system program transmitted from a host or a server.

The system area may include: a hidden area in which a user is not allowed to record and delete data, and management information of the USB memory device or a program to be executed or content to be played is recorded; and a system read/write area in which a user is not allowed to record and delete data, and a program executed or content played upon connecting the USB memory device to a USB host is recorded.

The data stored in the system area may be downloaded and updated from a USB host through the USB interface according to the update command for updating the system area.

The controller may use an authentication key stored in the system area to execute or play a program or content recorded on the system area, a public area, a remote server, or a host, or to determine whether or not there is authority to access user data recorded on the public area or to access the remote server.

According to another aspect of the present invention, there is provided a method of updating data in a system area of a USB memory device, the method including: receiving an update command for updating data in the system area when the USB memory device is connected to a USB host; determining whether or not it is necessary to change the size of the system area to execute the update command; and changing the size of the system area based on the determination and updating the data in the system area.

The operation of determining whether or not it is necessary to change the size may include: authenticating a user according to an authentication key recorded on the system area of the USB memory device; and, if the authentication is verified, determining whether or not it is necessary to change the size of the system area to execute the update command.

The data stored in the system area may be downloaded from the USB host and updated according to the update command.

The data stored in the system area may be a program executed or content played when the USB memory device is connected to the USB host.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a typical USB memory device;

FIG. 2 is a block diagram of a controller controlling a USB memory device;

FIG. 3A is a data storage area of a flash memory in a USB memory device according to an embodiment of the present invention;

FIGS. 3B to 3D are diagrams for explaining a position at which an update program for updating a system read/write area is stored in the flash memory depicted in FIG. 3A;

FIG. 4 is a flow chart of a process in which a host recognizes a USB memory device and displays drive information on the respective areas of a flash memory.

FIG. 5 is a flow chart of a process in which a host reads data stored in a USB memory device;

FIG. 6 is a flow chart of a process in which a host sends an update command for updating a system read/write area to a USB memory device; and

FIG. 7 is a flow chart of a process in which a USB memory device having received an update command updates a system read/write area.

### DETAILED DESCRIPTION OF THE INVENTION

Exemplary embodiments in accordance with the present invention will now be described in detail with reference to the accompanying drawings.

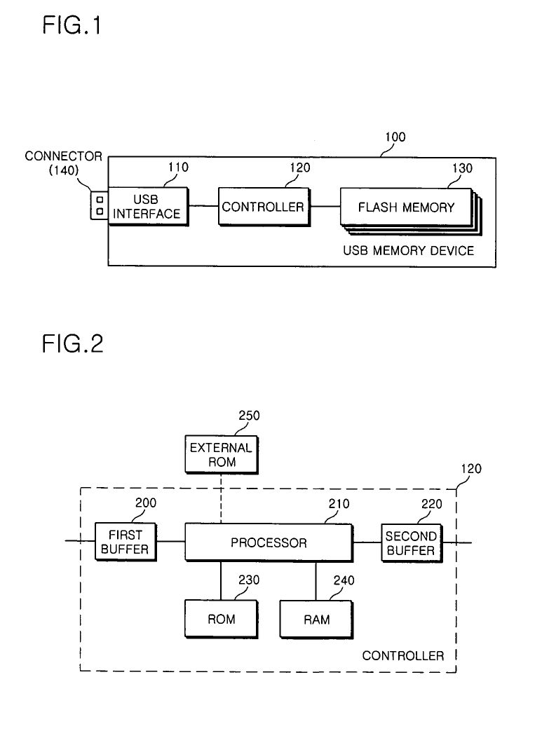

FIG. 1 is a block diagram of a typical Universal Serial Bus (USB) memory device.

The USB memory device 100 includes a USB interface 110, a controller 120, and a flash memory 130. The USB memory device further includes a USB connector 140. When the USB connector 140 is connected to a USB port of a host such as a personal computer (PC), the USB memory device is identified by the host. The USB interface 110 receives a USB signal from the host, divides the USB signal into an address and data, and transmits the address and data to the controller 120. The controller 120 refers to the address to determine a block of the flash memory 130 on which the data is written or read.

The controller 120 and the flash memory 130 may be integrated together rather than separated from each other.

FIG. 2 is a block diagram of the controller 120 controlling the USB memory device 100.

The controller 120 includes a first buffer 200, a processor 210, a second buffer 220, a read-only memory (ROM) 230, and a random-access memory (RAM) 240. Data received from the USB interface 110 is stored in the first buffer 200. The processor 210 calculates a position on which the data is to be recorded on the flash memory, and transmits the data to the second buffer 220. The ROM 230 stores a system program necessary for performing such a process. The RAM 240 is a memory necessary for executing the program. The system program may be stored in an external ROM 250 rather than in the ROM 230 provided inside the controller 120.

The system program cannot be re-recorded on the ROM 230 after it is recorded on the ROM 230. Accordingly, instead of the ROM, EEPROM may be used to update the system program repeatedly received from a host or server.

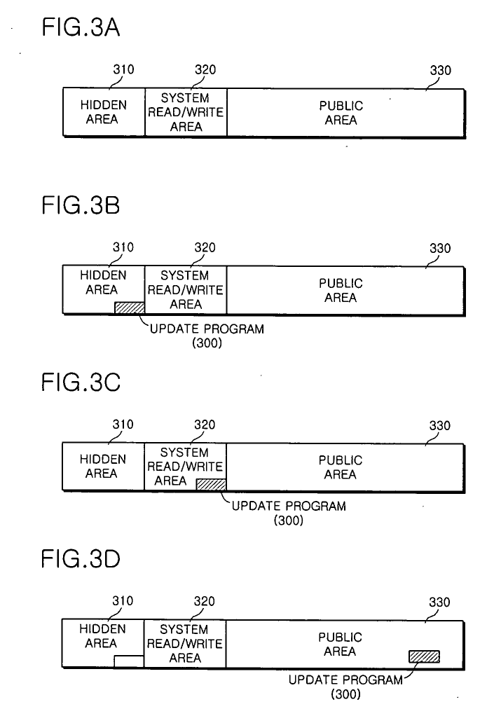

FIG. 3A illustrates data storage areas of a flash memory in a USB memory device according to an embodiment of the present invention.

The flash memory is divided into a hidden area 310, a system read/write area 320, and a public area 330. The flash memory may be divided in physical or logical manner. The term “logical manner” implies that the flash memory is divided, for example, by a program. A system area is composed of the hidden area 310 and the system read/write area 320. System data, such as Vendor ID (VID), Product ID (PID), and Electronic Serial Number (ESN), which are basic information of the USB memory device, are recorded on the hidden area 310.

The hidden area 310 stores programs or contents downloaded from a host or a remote server connected to the host. The hidden area 310 may store information created upon executing programs stored in the public area 330 or the system read/write area 320. Examples of the information include cookie information and logon information necessary for accessing a website. The information can be updated by an update program in the hidden area 320.

The programs or contents include data and files that can be played back. The entire data storage area may serve as the system read/write area 320 without additionally providing the public area 330.

An authentication key necessary for executing or playing programs or contents stored in a USB memory device may be stored. The authentication key may be used for authentication purposes when programs or contents stored in a host rather than in the USB memory device are executed or played. In addition, the authentication key may be sent to a remote server to determine whether or not the USB memory device is allowed to access the remote server. The authentication key may be stored in the system read/write area 320 as well as in the hidden area 310.

In addition, the authentication key may be used to access data recorded on the public area 330 or the system area. That is, if a user or a USB memory device using the authentication key is determined to be authorized, the program or content stored in the system area or the public area 330 is executed, or data recorded on the public area 330 is provided to the user.

That is, when a program stored in a USB memory device or a host is executed by the host, the program reads an authentication key and determines whether or not the authentication key is valid. If the authentication key is valid, the program is executed.

Meanwhile, the program or content may be stored and executed in the system read/write area 320 as well as in the hidden area 310. The program or content can be updated in the hidden area 310 or the system read/write area 320. Further, the size of the hidden area 310 or the size of the system read/write area 320 can change.

The authentication key may be recorded on a system area upon manufacture of a USB memory device such that the authentication key is assigned a unique key code. Also, the authentication key may be downloaded from a host or a remote server and be updated.

Instead of storing the authentication key upon manufacture, a program stored in the USB memory device and allowing access to a host or remote server may be used. That is, when the program is initially executed to access the host or remote server and a membership registration process is completed, membership information stored in the USB memory device may serve as an identification key.

In addition, when the authentication key is downloaded and updated from the host or remote server, the authentication key may be encrypted by an update program and stored in the system area. When a corresponding program reads the authentication key, the authentication key may be decoded by the update program and sent to the corresponding program.

Even though the authentication key may be stored in the system area, the authentication key is preferably stored in the hidden area 310 for security purpose.

Even though data recorded in the hidden area 310 is typically not displayed by the file explorer of the host, information concerning file or memory of the hidden area 310 can be displayed using utility software offered from the manufacturer of the USB memory device.

Data stored in the hidden area 310 is configured in a typical File Allocation Table (FAT) format used in Microsoft Windows OS and is combined with Application Programming Interface (API) of a manufacturer of the USB memory device, so that it cannot be displayed by the file explorer of the host or it can be independently defined and used.

The hidden area 310 may be a single area for storing both USB memory device management information, such as VID or PID, and software or content to be run. Alternatively, the hidden area 310 may consist of a plurality of areas for separately storing software or content to be run, or storing an authentication key.

Meanwhile, there has been a demand increase for an MP3 player equipped with Digital Rights Management (DRM) solution. That is, in a case where a MP3 player employs a data structure according to the embodiment of the present invention, a downloaded music file is stored in the hidden area and an authentication key is stored in the system area so that the music file can be played only in the MP3 player.

That is, since the music file stored in the hidden area can not be displayed through software other than utility software offered from the manufacturer, it becomes difficult to copy the music file. Further, even if the music file is copied to be played in another host, the music file can be played only when authentication is successful by inputting the authentication key stored in the system area.

Further, a music file with DRM protection may be stored in the public area 330 or host rather than in the hidden area and played using the authentication key in the system area.

When a new music file is downloaded to update an existing music file in the MP3 player, the existing music file recorded in the hidden area can be updated by an additional update program.

The authentication key may be software or part of software rather than a combination of data or numerals.

That is, when there are a music file with DRM protection and a software player for playing the music file, the software player may serve as an authentication key for playing the music file.

The system read/write area 320 stores programs executed or contents played when the USB memory device is connected to a USB port of the host. The public area 330 is an area in which data can be read and written by a user.

The public area 330 is divided into an area which is displayed on the file explorer upon insertion of a disk, and another area which is displayed on the file explorer upon entering a password or user information.

The respective sizes of the system read/write area 320 and the hidden area 310 can be changed, and the programs or contents recorded on the system read/write area 320 and the hidden area 310 can be updated. In the present embodiment, an updating process in the system read/write area 320 and a process for changing the size of the system read/write area 320 will be described. An updating process in the hidden area 310 and a process for changing the size of the hidden area 310 will not be described in the present embodiment since the processes are similar to those performed with the system read/write area 320.

According to an embodiment of the present invention, programs or contents in the system area can be updated using an update program. In addition, programs or contents downloaded from a host or a remote server can be stored in a public area and be updated.

The process for changing the size of the system read/write area 320 and the process for updating programs or contents are preferably performed by an update program stored in the flash memory beforehand. The update program may be stored and executed by the host.

The update program is connected to a network through the host, and downloads new programs or contents from the server to update existing programs or contents stored in the system read/write area 320. In addition, the update program changes the size of the system read/write area 320 for storing the programs or contents.

FIGS. 3B to 3D are diagrams for explaining a position at which an update program for updating the system read/write area 320 is stored in the flash memory of FIG. 3A.

The update program 300 is stored in the hidden area 310, the system read/write area 320, or the public area 330 as shown in FIG. 3B, 3C, or 3D, respectively.

The update program 300 is preferably stored in the hidden area 310 or the system read/write area 320 since the update program may be deleted by a user accidentally or intentionally if it is stored in the public area 330. If the update program is deleted, information necessary for updating cannot be exchanged with the host.

An updated program or content is stored in a USB host or a server connected to the USB host over a network. An update program may be updated by the host or server so that the update program can have more functions. For example, when the update program is stored in the hidden area 310 or the system read/write area 320, the update program may be updated while updating the programs or contents stored in the areas 310 and 320.

In addition, a program or content may be stored in the USB memory device and a program or content may be updated in the host rather than in the USB memory device. The program or content stored in the USB memory device and the program or content updated in the host may be combined and operated as though the program or content stored in the USB memory device were updated.

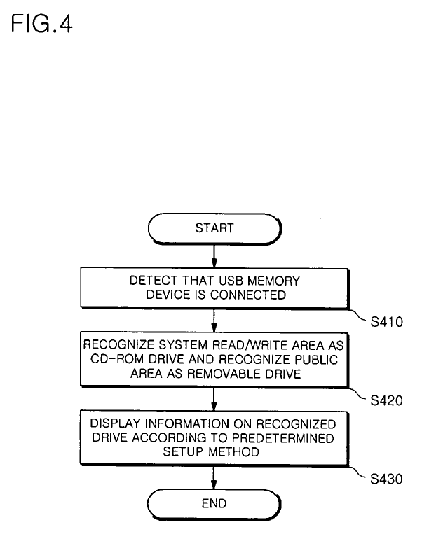

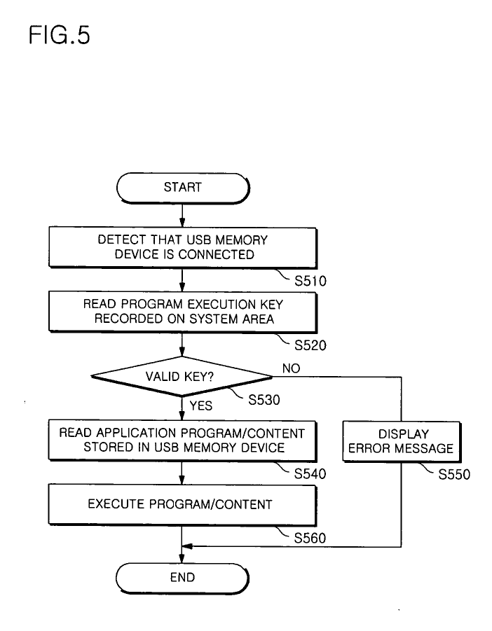

FIG. 4 is a flow chart of a process in which a host recognizes a USB memory device and displays drive information on the respective areas of a flash memory.

When a USB memory device is inserted into a USB port of a host, the host detects that the USB memory device has been inserted (operation S410). The USB memory device is automatically detected by the host since the host is typically equipped with Microsoft Windows OS that has a plug-and-play function. At this time, each of the storage areas in a flash memory is recognized as a drive (operation S420). For example, the system read/write area 320 is recognized as a CD-ROM drive in which a user is unable to write, and the public area 330 is recognized as a drive, such as a removable disk, in which the user is able to read and write.

Information concerning the drives which are differently recognized according to the respective areas is displayed to the user (operation S430). That is, the respective areas are automatically recognized as independent drives since control information necessary for recognizing the mass storage device class is provided in the operating system of the host, and a system program in a controller of the USB memory device is operatively associated with the host. Accordingly, the data area of the flash memory may be logically divided into a plurality of areas upon manufacture of the USB memory device so that the areas can be recognized as two or more drives. The respective areas may be recognized as CD-ROM drive or removable disk drive. The process for recognizing drives depends on the system program of the controller 120.

Conventionally, a read-only memory area such as CD-ROM area is determined beforehand upon manufacture of a storage medium, and data recorded on the read-only memory area can be read but not written by the user. Accordingly, the data stored in the read-only memory area (e.g., CD-ROM area) cannot be deleted or updated by the user. However, according to an embodiment of the present invention, even though the data stored in the read-only memory area cannot be deleted or updated by the user, the data stored in the read-only memory area such as CD-ROM area can be repeatedly updated and the size of the read-only memory area can be changed based on the size of the updated data by the update program stored in the USB memory device.

When a program or content recorded on a system area is updated, an update program is operatively associated with a system program of a controller in the USB memory device. The system program of the controller in the USB memory device is programmed to operatively associated with the update program.

FIG. 5 is a flow chart of a process in which a host reads data stored in a USB memory device.

A process for reading and executing data stored in the USB memory device according to a key value recorded on a system area of the USB memory device will now be described with reference to FIG. 5.

When it is detected that a USB memory device is connected to a USB port of a host (operation S510), an authentication key recorded on the system area is read (operation S520). The authentication key is used to perform an authentication process when data stored in a flash memory is read and written, or when a program or content recorded on a system read/write area 320, a public area 330, or a host is executed or played back.

The authentication key may be used as a unique key for automatically accessing a file of a host or a remote server. For example, when the USB memory device is inserted to the host, a predetermined file of the host is automatically executed, or the host is automatically connected to a predetermined website.

Meanwhile, when used as the authentication key for automatically accessing a website, the authentication key may have Internet address information.

Subsequently, it is determined whether or not the read authentication key is a key of an authorized user having access to data stored in the USB memory device (operation S530). If the authentication key is determined to be a key of an authorized user, an application program or content stored in the USB memory device is read (operation S540) and executed (operation S560). The application program or content may be automatically executed or played when the USB memory device is connected. If the authentication key is not determined to be a key of the authorized user, an error process is performed, e.g., an error message is displayed (operation S550).

The authentication key may be recorded upon manufacture of the USB memory device, or may be updated by the host or remote server. For example, it may be updated at the same time when a hidden area or a system read/write area is updated. In that case, since user authentication can be performed at any time, it is possible to improve security capability and to use the authentication key to charge the user for services. That is, the authentication key may be used to determine what programs or contents the user has downloaded from the remote server.

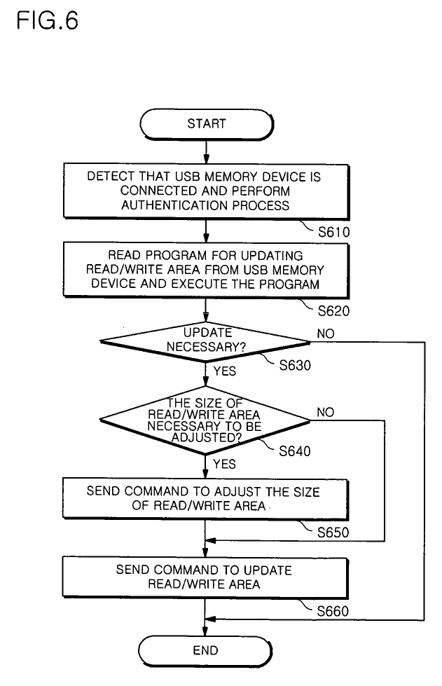

FIG. 6 is a flow chart of a process in which the host sends an update command for updating the system read/write area 320 to a USB memory device.

When it is detected that a USB memory device is connected, an authentication process is performed (operation S610). The authentication process may be performed by using an authentication key as described above, or may be performed by using a unique embedded number. The unique embedded number is similar to a serial number assigned upon manufacturing the USB memory device. The authentication process may be performed by sending a unique identifier of the USB memory device to a host. The unique identifier may consist of a combination of characters or a combination of symbols and characters different from the unique embedded number.

The above-mentioned authentication key, unique embedded number and unique identifier may be separately stored in the USB memory device. The authentication key, unique embedded number, and unique identifier may have different data type but are similar to each other in terms of their object and effect. The authentication key, unique embedded number, and unique identifier are preferably recorded upon manufacturing the USB memory device, but may be stored afterwards. For example, when the USB memory device is first inserted to the host, Microsoft's KeyGen (Key Generator) software, which is stored in a system area, may generate and store a unique value in the system area. If necessary, the operation S610 may be omitted.

An update program for updating the system read/write area in the USB memory device is read and executed (operation S620). After information necessary for updating is downloaded, it is determined if the system read/write area needs to be updated (operation S630). For one example, since a program or content stored in the system read/write area includes version information, it is possible to determine whether to update the program or content by comparing the version information of the program or content stored in the system read/write area with version information of a newly downloaded program or content. For another example, if a unique identifier of the USB memory device and content or program information stored in the system area are sent to the host or remote server, the program or content stored in the USB memory device can be updated according to whether or not the information is valid.

For another example, an update program recorded in the system read/write area may store in the system read/write area the same information as at least one program stored in a public area. If the program stored in the public area is deleted, the program may be copied by the update program from the system read/write area to the public area or hidden area.

This process is performed by the update program and the system program stored in the controller 120.

New programs or contents and information necessary for updating may be stored in the host, or may be received from the remote server connected over the network.

When an updating process is determined to be necessary, it is determined whether or not the size of the system read/write area needs to be adjusted to perform the updating process (operation S640). If the size of the updated program or content is larger than that of an original program or content, it is necessary to increase the size of the system read/write area to store the updated program or content. If the size of the updated program or content is smaller than that of an original program or content, it is necessary to decrease the size of the system read/write area so that the user can use a larger public area or hidden area to store user data.

If the system read/write area is large enough, it is not necessary to adjust the size of the system read/write area. However, if the size of the updated or added data is larger than the size of the system read/write area determined upon manufacturing the USB memory device, the size of the system read/write area needs to be adjusted.

If it is necessary for the size of the system read/write area to be adjusted, a command for adjusting the size of the system read/write area is sent to the USB memory device (operation S650) and an update command is sent (operation S660). If it is not necessary for the size to be adjusted, an update command is directly sent (operation S660).

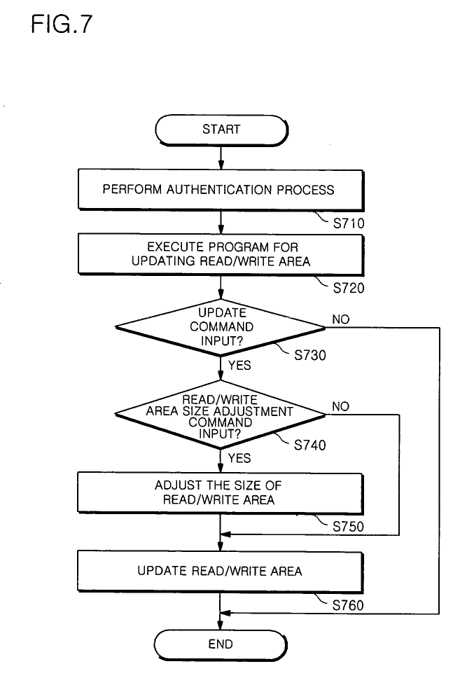

FIG. 7 is a flow chart of a procedure in which a USB memory device having received an update command updates the system read/write area 320.

If an authentication process is necessary prior to using the USB memory device, the authentication process is first performed (operation S710). After a program for updating the system read/write area is executed (operation S720), it is determined whether or not an update command is input (operation S730). If the update command is input, it is further determined whether or not a command for adjusting the size of the system read/write area is input (operation S740). If the command for adjusting the size of the system read/write area is input, the size of the system read/write area is adjusted (operation S750). If the command for adjusting the size of the system read/write area is not input, the program or content stored in the system read/write area is updated (operation S760).

The method of updating a system area of a flash memory according to an embodiment of the present invention, which is described in detail with reference to FIG. 7, may be adapted to an MP3 player employing a flash memory or a hard disk memory as well as the USB memory device. In addition, the method may be adapted to a digital camera or mobile phone including a basic structure of the USB memory device.

Meanwhile, the above-mentioned method of updating a system area of a flash memory may be written in a computer program. Codes and code segments constituting the program can be easily deduced by computer programmers skilled in the art. Also, the program is stored in a computer readable medium and is read and executed by a computer to implement the method of updating the system area of a flash memory. Examples of the computer readable medium include a magnetic recording medium, an optical recording medium, and a carrier wave medium.

As apparent from the above description, according to the present invention, it is possible to repeatedly update programs or content stored in the system area of the USB memory device and to adjust the size of the system area.

That is, it is possible to easily update the programs or content recorded on the system area through a server connected to a USB host or a network without the need to collect the USB memory device from a user.

In addition, an authentication key is provided, which is necessary to perform the program or content stored in the USB memory device or host. The authentication key is useful in programs or contents requiring security.

Further, it is possible to update a program or content stored in the system area through an update program, and to easily update a program or content downloaded to a public area.

While the present invention has been described with reference to exemplary embodiments thereof, it will be understood by those skilled in the art that various changes in form and details may be made therein without departing from the scope of the present invention as defined by the following claims.

What is claimed is:

1. A data structure of a memory in a USB (Universal Serial Bus) memory device, comprising:
a system area in which a user is not allowed to record or delete data, management information of the USB memory device and a program or content executed or played upon connecting the USB memory device to a host are recorded, and a program or content is added or updated by an update program.

2. The data structure of claim 1, further comprising a public area in which a user is allowed to record and delete data.

3. The data structure of claim 1, wherein the system area comprises:
a hidden area in which a user is not allowed to record and delete data, and management information of the USB memory device or a program to be executed or content to be played is recorded; and
a system read/write area in which a user is not allowed to record and delete data, and a program executed or content played upon connecting the USB memory device to a USB host is recorded.

4. The data structure of claim 3, wherein the system read/write area and the hidden area vary in size.

5. The data structure of claim 3, wherein the hidden area is not displayed through a file explorer incorporated in the host.

6. The data structure of claim 1, wherein the system area stores an authentication key necessary in executing or playing a program or content recorded on the system area, a public area, the host, or a remote server, or in acquiring authority to access user data recorded on the public area or to access the remote server connected to the host.

7. The data structure of claim 6, wherein
the authentication key is recorded upon manufacture of the USB memory device,
the authentication key is generated by an authentication key generation program stored in the USB memory device and is recorded on the USB memory device,
the authentication key is generated by a user and is recorded on the USB memory device, or
the authentication key is updated through the host.

8. The data structure of claim 1, wherein the update program is stored in the system area or public area of the memory, the host, or a remote server.

9. The data structure of claim 1, wherein the update program transmits program or content information recorded on the system area or public area of the USB memory device to the host or a remote server.

10. The data structure of claim 1, wherein the update program transmits information concerning the update program to a remote server, and the update program is updated by downloading a new update program from the host or the remote server.

11. The data structure of claim 1, wherein the system area stores the same information as at least one program or content stored in a public area, and, if the program or content stored in the public area is deleted, a corresponding program or content is copied from the system area to the public area.

12. The data structure of claim 2, wherein the public area, hidden area, or system read/write area stores a program or content downloaded from a host or a remote server by a predetermined update program.

13. The data structure of claim 3, wherein the public area, the hidden area, or the system read/write area stores a program or content downloaded from a host or a remote server by a predetermined update program.

14. The data structure of claim 3, wherein the hidden area stores information created or processed in executing a program stored in the system read/write area, the public area, or the host.

15. A USB memory device comprising:
at least one flash memory;
a USB interface; and
a controller that receives an update command for updating data stored in a system area of the flash memory in which a user is not allowed to record and delete data, and performs an update process.

16. The USB memory device of claim 15, wherein the flash memory comprises a system area in which a user is not allowed to record or delete data, management information of the USB memory device and a program or content executed or played upon connecting the USB memory device to a host are recorded, and a program or content is added or updated by an update program.

17. The USB memory device of claim 16, wherein the flash memory further comprises a public area in which a user is allowed to record and delete data.

18. The USB memory device of claim 16, wherein a part or the entire of a program or content stored in the system area is stored in a host or a public area, and a program or content stored in the host or the public area is updated.

19. The USB memory device of claim 15, wherein the controller uses an EEPROM rather than a ROM to update a system program to another system program transmitted from a host or a server.

20. The USB memory device of claim 16, wherein the system area comprises:
a hidden area in which a user is not allowed to record and delete data, and management information of the USB memory device or a program to be executed or content to be played is recorded; and
a system read/write area in which a user is not allowed to record and delete data, and a program executed or content played upon connecting the USB memory device to a USB host is recorded.

21. The USB memory device of claim 16, wherein the data stored in the system area is downloaded and updated from a USB host through the USB interface according to the update command for updating the system area.

22. The USB memory device of claim 15, wherein the controller uses an authentication key stored in the system area to execute or play a program or content recorded on the system area, a public area, a remote server, or a host, or to determine whether or not there is authority to access user data recorded on the public area or to access the remote server.

23. The USB memory device of claim 22, wherein
the authentication key stored in the system area is stored upon manufacture of the USB memory device,
the authentication key is generated by an authentication key generation program stored in the USB memory device and is recorded on the USB memory device,
the authentication key is generated by a user and is recorded on the USB memory device, or
the authentication key is updated through the host.

24. The USB memory device of claim 16, wherein the update program transmits information concerning the update program to a remote server, and the update program is updated by downloading a new update program from the host or the remote server.

25. The USB memory device of claim 16, wherein the update program transmits program or content information recorded on the system area or public area of the USB memory device or the host to a remote server.

26. The USB memory device of claim 16, wherein the system area stores the same information as at least one program or content stored in the public area, and, if the program or content stored in the public area is deleted, a corresponding program or content is copied from the system area to the public area.

27. The USB memory device of claim 17, wherein the public area, the hidden area, or the system read/write area stores a program or content downloaded from a host or a remote server by a predetermined update program.

28. The USB memory device of claim 20, wherein the public area, the hidden area, or the system read/write area stores a program or content downloaded from a host or a remote server by a predetermined update program.

29. The USB memory device of claim 20, wherein the hidden area stores information created or created in executing a program stored in the system read/write area, the public area, or the host.

30. A method of updating data in a system area of a USB memory device, the method comprising:
receiving an update command for updating data in the system area when the USB memory device is connected to a USB host;
determining whether or not it is necessary to change the size of the system area to execute the update command; and
changing the size of the system area based on the determination and updating the data in the system area.

31. The method of claim 30, wherein the operation of determining whether or not it is necessary to change the size comprises:
authenticating a user according to an authentication key recorded on the system area of the USB memory device; and
if the authentication is verified, determining whether or not it is necessary to change the size of the system area to execute the update command.

32. The method of claim 30, wherein data stored in the system area is downloaded from the USB host and updated according to the update command.

33. The method of claim 31, wherein data stored in the system area is downloaded from the USB host and updated according to the update command.

34. The method of claim 30, wherein the data stored in the system area is a program executed or content played when the USB memory device is connected to the USB host.

35. The method of claim 31, wherein the data stored in the system area is a program executed or content played when the USB memory device is connected to the USB host.
